(19) United States
(12) Patent Application Publication
(10) Pub. No.: US 2004/0128170 A1
(43) Pub. Date: Jul. 1, 2004

(54) Method for intergrating insurance quotation, payment and issuance to mortgage loan origination process

(76) Inventors: Edwin Robeson MacKethan, San Francisco, CA (US); James Win Ellsworth, Reno, NV (US)

Correspondence Address: FloodExpress LLC, PO Box 8104, Reno, NV, 89507, US

(21) Appl. No.: 10/328,117

(22) Filed: Dec. 19, 2002

(51) Int. Cl. G06F 17/60

(52) U.S. Cl. 705/4; 705/38

(57) ABSTRACT

A means for electronically quoting, taking an application for, making payment for, and issuing flood, homeowners and other hazard insurance as an integrated part of the loan origination process by utilizing electronic communication protocols to send and retrieve data from disparate databases, database technologies to store and manipulate data, fillable form technologies, and secure, online payment technologies. By electronically linking several electronic mortgage service systems and insurance quotation/application systems, the inventors show how to create an automated system for quotation, application, premium payment and issuance of flood, homeowners and other hazard insurance policies within the mortgage loan origination process.

### FIELD OF THE INVENTION

The present Invention relates generally to the use of computer systems to price, issue and deliver insurance products to mortgage originators proposing to lend monies secured by collateral that the lender requires to be insured prior to funding. Accordingly, this patent application may be a Class 705 application.

### CROSS REFERENCE TO RELATED APPLICATIONS

Not applicable

### FEDERALLY SPONSORED RESEARCH

Not applicable

REFERENCES

| | | | |
|---|---|---|---|
| U.S. Pat. No. 5,873,066 | Underwood et al. | Feb. 16, 1999 | 705/4 |
| U.S. Pat. No. 4,831,526 | Luchs et al. | May 16, 1989 | 705/4 |
| U.S. Pat. No. 5,523,942 | Tyler et al. | Jun. 4, 1996 | 705/4 |

### BACKGROUND OF THE INVENTION

During the mortgage origination process most mortgage settlement services are electronically ordered and delivered to the loan origination officer of the lending institution. To date however, flood and other hazard insurance for the prospect mortgage collateral have only been available via a separate process that is initiated, applied for, and paid for by the proposed borrower prior to loan funding (closing). This discontinuity in the mortgage origination process creates impediments to the lender closing the loan. With the enactment of recent laws allowing mortgage lenders to own or be affiliated with licensed insurance agencies and the advent of technologies that allow disparate remote databases to share data required for the application, payment and issuance of insurance products, the inventors have created a method to integrate and automate the application, payment and issuance of flood and other hazard insurance to the mortgage origination process.

Currently, upon application for a mortgage loan by a prospective borrower, a mortgage loan officer inputs the borrower's transaction data into a Loan Origination System software package (an “LOS”). This information includes Name, address, social security number and other relevant personal information. It also includes the proposed real property address and description (the “Address Data”) and the proposed terms of the loan. The Address Data is transmitted to a flood zone determination service. Typically, this transmission is performed by direct entry of Address Data into a browser-based website by a loan processor or, in the preferred embodiment the Address Data may be transmitted via an XML or other data exchange technology directly from the LOS. The Address Data is compared by the flood zone determination service against the Federal Emergency Management's National Flood Insurance Program maps in order to determine if the property lies within a federally defined flood zone. The results of that determination (the “Flood Data”) are required to become a part of the lender's loan processing file. If the property does not lie within a flood zone no further action is required by the lender. If the property lies within a flood zone (a “Positive Determination”), then the lender is required to inform the borrower that the property lays within a flood zone and that proof of flood insurance is required by law before a loan can be closed. (Note: some Positive Determinations give rise to eligibility for voluntary flood insurance coverage.) This notification and determination are typically delivered to the lender from the flood zone determination service via the internet. The notice of the flood zone determination is communicated to the borrower verbally and in the loan approval package along with directions to secure the requisite insurance policies. Heretofore, when flood or other hazard insurance has been required by law (or eligible) to be in place prior to the closing of a mortgage loan, the mortgage loan officer has simply required that the borrower secure its own flood or other hazard insurance policy outside of the normal electronic ordering, delivery and management systems operated by the lending institutions to provide other mortgage settlement services. (Typically, settlement services, such as title reports, title insurance, appraisals, credit reports and flood zone determination are ordered by and delivered to the loan originator (lending institution) electronically.)

The present Invention commences at this point of the mortgage origination process and presents to the lender (via its affiliated insurance agency) and prospective borrower an opportunity to automatically quote, apply, bind and issue flood or other hazard insurance at the closing of escrow. The inclusion of the Invention into the loan origination process benefits the lender by providing point of sale earnings opportunities and eliminating workflow discontinuities. It benefits the borrower by providing a convenient, direct way to provide required proofs of insurance at loan closing.

The Invention creates a method and technology (in the form of computer software, data manipulation and workflow engineering) for integrating the automated quotation, application, payment and issuance of mortgage-related insurance into the loan origination process and into the software used by lending institutions. In its preferred embodiment the Invention can be used by the mortgage bank's affiliated insurance agency to automatically place flood insurance and other hazard insurance (e.g., homeowners insurance) with a borrower concurrently with the funding of a mortgage loan.

### SUMMARY OF THE INVENTION

The present Invention provides a means for identifying instances for required insurance coverage during the loan application process. Uses data communication technologies to communicate with disparate databases to extract and compile data required to underwrite, pay for and issue flood and other hazard insurance polices. The present Invention uses data extracted from a number of sources to build an insurance application and deliver the completed application to an insurance carrier's underwriting system; and to communicate underwriting approval and pricing within the loan application process. The present Invention also provides a means for funding and delivering the insurance premium and issuing the insurance policy at the loan closing.

### BRIEF DISCRIPTION OF DRAWINGS

FIG. 1 is a flow diagram showing the Invention workflow in its preferred embodiment, along with various subroutines for exception processing.

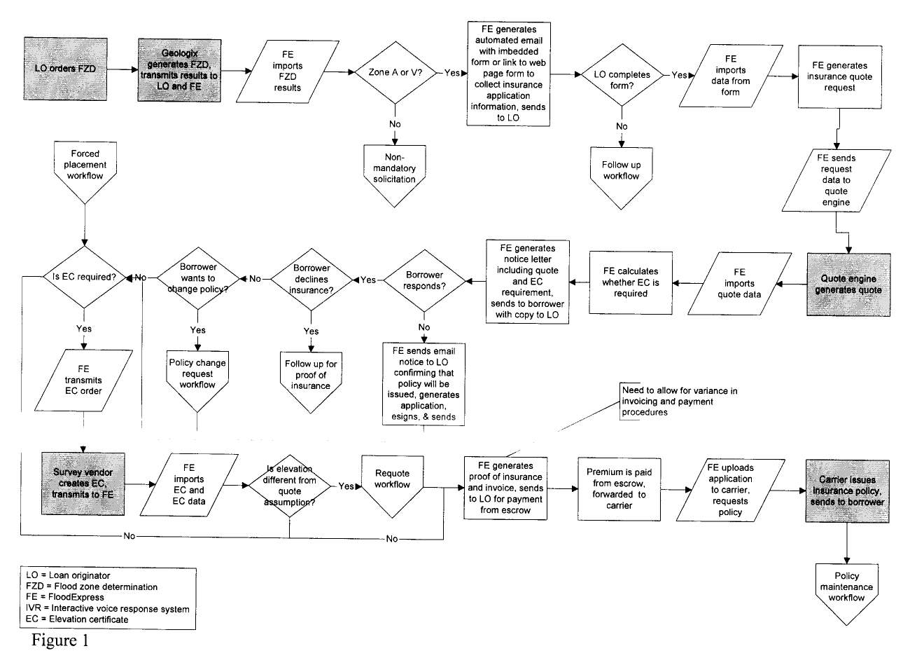

### THE INVENTION

The inventors have discovered that an insurance agency (the “Agency”) can use a data transmission, preferably an XML data or other “pure” data stream, to receive notice of a Positive Determination (or other hazard insurance requirement or eligiblity) associated with a proposed mortgage loan and the Address Data (see defined terms above) from the flood zone determination service and use this information to generate a partial flood (or other hazard) insurance quote application (“Step One Data”). The Step One Data is stored in a central database (the “Core Database”) and is associated with a proposed loan file for a client lending institution (the “Loan File”).

A data stream, email or other data communication method can then be utilized to request additional information from the loan officer and/or the LOS or a third party service of certain property attributes, such as year built, number of floors, existence of a basement, type of structure and other fields required by the insurance underwriter (the “Property Attributes”). Depending on the needs of the lending institution, the Property Attributes can be requested in one of four ways (each a separate process). In its preferred embodiment, the Property Attributes can be extracted as data elements to the Core Database from the LOS where such Property Attributes have been provided as data to the LOS by a third party service such as a title report, an automated valuation system or another appraisal service. Alternatively, Property Attributes can be requested and delivered to the Core Database by XML or another data exchange technology from a third party data provider contracting directly with the user of the Invention. Property Attributes can also be requested by email to the loan officer containing an embedded, active HTML form containing the Step One Data and active boxes for the input and reply by the Lending Institution. Alternatively, the Email can contain an active hyperlink to an HTML form containing the Step One Data and active blank spaces for the Lending Institution to fill in the Property Attributes and return to the Core Database. The Property Attributes are stored on the Core Database and associated with the Loan File.

The Flood Data, Step One Data, and Property Attributes (the “Initial Flood Quote Data”) can be extracted from the Core Database and combined to build a defined field insurance quote application as required by the proposed underwriter of the insurance policy (the “Quote Application”). The Quote Application can then be submitted via the internet or other communication medium to a computer running rating software operated by an insurance carrier and a premium quote is generated therefrom (the Initial Flood Quote”). The Initial Flood Quote data can then be extracted from the rating software via an XML or other data exchange and stored in the Core Database. Besides providing a premium quotation, the Initial Flood Quote will also indicate whether an elevation certificate is required by law to underwrite and purchase the quoted policy. This elevation certificate determination is made by the insurance underwriter by means of referencing the date of construction Property Attribute with the date the property became a part of the National Flood Insurance Program (a data point derived from a flood zone determination).

The Loan File within the Core Database is then accessed to populate a form letter to the Borrower (copy to Lender) with notification of a Positive Determination, the flood insurance requirements under the law, the Initial Flood Quote, notice that an Elevation Certificate is required by law (if required), and an offer to allow the Agency licensing the Invention to secure the Elevation Certificate, cause the issuance of the policy and the deduction and payment of the insurance premium and elevation certificate cost at the closing of escrow (the “Offer”). If the Borrower contacts the Insurance Agency with a request to change the insurance coverage quoted the Policy Change Request Workflow is initiated.

In the preferred embodiment, if the borrower does not decline the Offer and an Elevation Certificate is required by law, the Agency populates an Elevation Certificate Order form (a form resident in the Core Database with the Initial Flood Quote Data and emails (or uses another communication medium) the Elevation Certificate Order Form to a provider of Elevation Certificates (typically a survey company) (the “Elevation Certifier”). Alternatively, the loan officer (or other lending institution or Agency employee) can contact the borrower to receive authorization to order the Elevation Certificate and appropriate payment protocols (for example, a credit card account to be charged in the event the Loan fails to close for any reason).

In its preferred embodiment, the Elevation Certifier provides the Elevation Certificate as a data stream via XML or other data exchange protocol through a communication medium such as the internet. Such data is associated with the Loan File and stored in the Core Database. The Elevation Certifier stores a hard copy of the Elevation Certificate. The Elevation Certificate data is sent to the underwriting insurance carrier using the communication medium required by the carrier, preferably an XML data stream via the internet.

Upon receipt of the Elevation Certificate by the insurance carrier, the data contained therein is compared to the Initial Flood Quote Data. In its preferred embodiment, the carrier rating software performs this comparison electronically. If the data differ, then the Requote WorkFlow is initiated and a final insurance quote is generated and sent to the proposed borrower and the loan officer by email or another communication medium, (e.g., a form letter residing in the Core Database).

The data contained in the Initial Flood Quote (or, if different, the final insurance quote generated by the Requote Workflow) can then be used to perform two tasks: 1) an html or PDF Insurance Application populated with the requisite data extracted from the Core Database can be generated, electronically signed by the authorized insurance agent, and transmitted to the insurance underwriter by email or other communication medium; and 2) notification can be sent to the lender and escrow company that a policy is ready to be issued at the loan closing by deduction from escrow of the insurance premium and the elevation certificate cost. This notification takes place in one or both of two ways; in the preferred embodiment, by direct transmission to the LOS by XML or other data exchange technologies, or by email to the Lending Officer and Escrow Officer.

In the preferred embodiment, upon the Closing of the loan the insurance premium is paid into an insurance carrier account at the lending institution by the escrow company or, alternatively, payment is otherwise made (e.g., certified check from the escrow company to the carrier). Simultaneously therewith, the insurance carrier provides notice to the borrower and lender that a flood insurance policy protecting the collateral has been issued. The cost of the Elevation Certificate (if any) is similarly deducted at escrow close and deposited to the credit of the Elevation Certifier. The carrier or Elevation Certifier can electronically sweep these bank accounts at regular intervals.

The insurance carrier issues the insurance policy and sends it to the Borrower by email or a hard copy via US Mail.

What is claimed is:

1. A computer implemented system for offering, quoting, applying for and issuing flood insurance policies to home loan borrowers at the point of loan origination, comprising:
(A) A means for receiving notice from a flood zone determination service that the proposed collateral (property) of a mortgage loan lays within a FEMA flood zone,
(B) A means for receiving from a loan originator, storing and associating property and borrower statistics with a proposed mortgage loan,
(C) A means for accessing, receiving and storing additional property data from third party service providers for said proposed mortgage loan,
(D) A database means for storing, manipulating and associating a plurality of property and borrower data with a proposed mortgage loan containing at least the property address, FEMA flood zone, Lender, and proposed borrower,
(E) A means for extracting and combining said property and borrower data to produce a flood insurance quote request form,
(F) A means for delivering the quote request form to a third party flood insurance provider,
(G) A means for receiving, storing and associating with said proposed mortgage loan an initial flood insurance quote,
(H) A means for conveying a flood insurance quote and offer to sell a flood insurance policy to a proposed borrower at the time of loan approval,
(I) A means receiving notice of additional flood application requirements (if any) to produce a final flood insurance quote, including, at least an elevation certificate,
(J) A means for ordering, receiving, storing and associating with said proposed mortgage loan an elevation certificate,
(K) A means for requoting the flood insurance quote using data derived from said elevation certificate,
(L) A means for reconveying said flood insurance quote as a final flood insurance quote and offer to sell a flood insurance policy to a proposed borrower.
(M) A means for receiving acceptance from said proposed borrower of said offer to sell such flood insurance policy,
(N) A means for extracting borrower and property data to populate a flood insurance application, electronically execute such application and convey such application to the insurance carrier,
(O) A means for receiving and transmitting payment of said flood insurance policy premium and elevation certificate at the closing of said mortgage loan,
(P) A means for delivering notice of the issuance of a flood insurance policy to lender and borrower,
(Q) A means for storing and managing a plurality of flood insurance solicitations and policies associated with a mortgage lender's clientele.

2. The system of claim 1 wherein the product offered is homeowners insurance.

3. The system of claim 1 wherein the product offered is excess flood insurance.

4. The system of claim 1 wherein the product offered is earthquake insurance.

5. The system of claim 1 wherein the product offered is a hazard insurance policy protecting the collateral of a mortgage lender from a casualty loss.

6. The system of claim 1, wherein said computer implemented system is formed of a plurality of remote workstations each of which is electronically coupled to a network server located at a home office, said database means being coupled to said network server at said home office.
